(19) United States
(12) Patent Application Publication
(10) Pub. No.: US 2008/0045173 A1
(43) Pub. Date: Feb. 21, 2008

(54) Apparatus and method for schedule management in mobile terminal

(75) Inventors: Seon Young Park, Gumi-si (KR); Young June Ahn, Metropolitan City (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/643,920

(22) Filed: Dec. 22, 2006

(30) Foreign Application Priority Data
Aug. 18, 2006 (KR) 2006-77934

(51) Int. Cl. H04B 1/18

(52) U.S. Cl. 455/187.1

(57) ABSTRACT

An apparatus and a method for managing schedule information in a mobile terminal are provided. The method includes converting, if the location of the mobile terminal changes, an execution time of a schedule to a local time of a city in which the mobile terminal is located and notifying, if the location of the mobile terminal does not change, the schedule at the converted execution time. Accordingly, the present invention provides an apparatus and a method for conveniently managing a schedule to be executed according to the location of the mobile terminal.

### CROSS-REFERENCE TO RELATED APPLICATIONS

This application claims the benefit under 35 U.S.C. § 119(a) of Korean Patent Application Serial No. 2006-0077934 filed in the Korean Intellectual Property Office on Aug. 18, 2006, the entire disclosure of which is hereby incorporated by reference.

### BACKGROUND OF THE INVENTION

1. Field of the Invention

The present invention relates to a mobile terminal. More particularly, the present invention relates to an apparatus and a method for providing a schedule management function in a mobile terminal.

2. Description of the Prior Art

With recent development in communication technology, various mobile terminals, such as mobile phones, notebook computers, and personal digital assistants (PDA), have been popularized. Among the mobile terminals, mobile phones are very popular and provide various functions, such as an electronic organizer and wireless Internet in addition to their basic function of telephone communication.

Among the various functions provided by the mobile terminals, the electronic organizer provides a simple function of storing and retrieving schedules and memos. In a schedule management function provided by the conventional electronic organizer, execution times of a schedule must be converted to the local time of the city in which the mobile terminal is located. Therefore, in the case of traveling to several cities in the world, it becomes inconvenient to manage schedules due to the need for converting the execution time of the schedule to the local time of a corresponding city.

Additionally, a world time function of the conventional electronic organizer is limited to providing only date and time for major cities in the world, or to displaying names of cities located in the same time zone.

Accordingly, there is a need for an improved apparatus and method for schedule management in a mobile terminal.

### SUMMARY OF THE INVENTION

Exemplary embodiments of the present invention have been made in view of the above problems and/or disadvantages and provide at least the advantages described below. Accordingly, an object of the present invention is to provide an apparatus and a method for managing a schedule according to local times of major cities in the world by synchronizing a schedule management function with a world time display function in an electronic organizer of a mobile terminal.

Another object of the present invention is to provide an apparatus and a method for displaying, on a mobile terminal, a world map and execution time of a schedule registered for a city, when a user searches schedule information by major cities in the world.

In order to achieve the above objects, a schedule management method in a mobile terminal according to an exemplary embodiment of the present invention includes converting, if the location of the mobile terminal changes, an execution time of a schedule to a local time of a city in which the mobile terminal is located and notifying, if the location of the mobile terminal does not change, the schedule at the converted execution time.

A mobile terminal for storing schedule information according to an exemplary embodiment of the present invention includes an input unit for inputting a signal for storing or searching the schedule information, and transmitting the signal to a control unit, a display unit for displaying an input screen of registering or searching the schedule information, and for notifying the schedule information, a storage unit for storing the schedule information, location of cities and time difference by cities, and world map data, a location calculator for calculating a location in which the mobile terminal is currently located by using a signal received from a GPS receiver, a world time calculator for calculating the time difference between the local time of a city in which the mobile terminal is located and the local time of a correspondence city by using the locations and time differences stored in the storage unit, a schedule information extractor for extracting the location of a city calculated by the location calculator and schedule information corresponding to a city name input by a user and an alarm generator having at least one of a speaker, vibrator, and lamp, for generating an alarm at a certain time to notify of the extracted schedule information.

### BRIEF DESCRIPTION OF THE DRAWINGS

The above and other objects, features and advantages of the present invention will become more apparent from the following detailed description in conjunction with the accompanying drawings, in which:

FIG. 1 is a block diagram showing a configuration of a mobile terminal according to an exemplary embodiment of the present invention;

FIG. 2 is a flow chart showing a method for registering schedule information in a mobile terminal according to an exemplary embodiment of the present invention;

FIG. 3 is a flow chart showing the inputting of a city name in an exemplary method for registering schedule information of FIG. 2;

FIG. 4 is a flow chart showing the inputting of a schedule item in an exemplary method for registering schedule information of FIG. 2;

FIG. 5 is a flow chart showing the inputting of a memo in an exemplary method for registering schedule information of FIG. 2;

FIG. 6 is a flow chart showing a method for notifying a schedule in a mobile terminal according to an exemplary embodiment of the present invention;

FIG. 7 is a flow chart showing a method for searching a schedule in a mobile terminal according to an exemplary embodiment of the present invention;

FIG. 8 is a flow chart showing another method for searching a schedule in a mobile terminal according to another exemplary embodiment of the present invention;

FIG. 9 is a view showing examples of screen displays for registering schedule information according to an exemplary embodiment of the present invention; and

FIG. 10 is a view showing examples of screen displays for searching registered schedule information according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness. Hereinafter, exemplary embodiments of the present invention are described in detail with reference to the accompanying drawings.

In the specification, ‘schedule information’ means a work schedule to be executed by a user at a specific time in a specific city, and includes information registered by mapping the schedule to a city name. For this, the schedule information may include a city name, schedule, and memo. The schedule includes a schedule item, correspondence city name, and execution time. The execution time means the time at which the schedule is executed, and the correspondence city name means a name of a city in which the other party of the schedule is located, or, if there is no other party, the city in which the user is located.

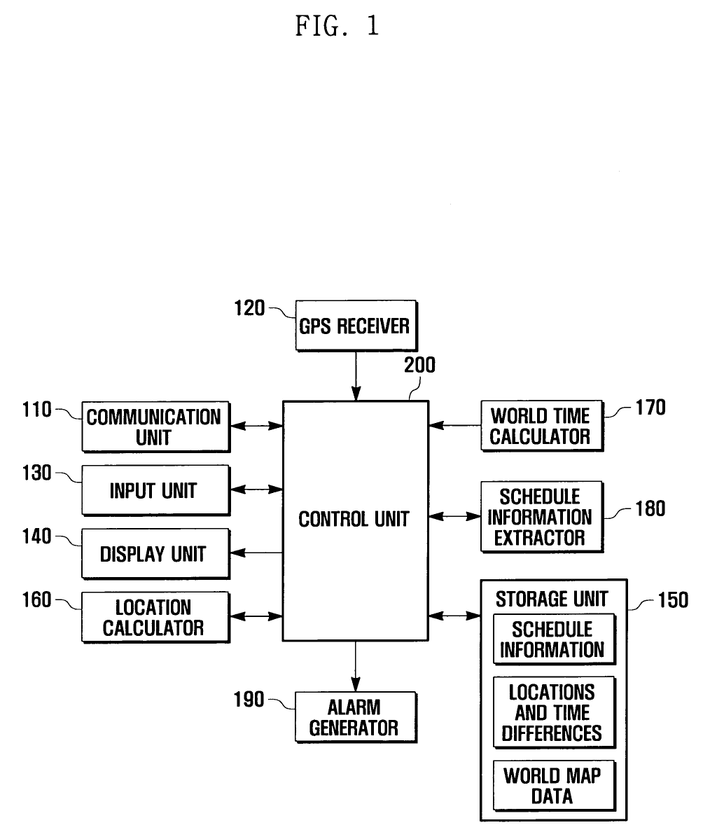

FIG. 1 is a block diagram showing a configuration of a mobile terminal according to an exemplary embodiment of the present invention.

Referring to FIG. 1, the mobile terminal includes a communication unit 110, GPS (global positioning service) receiver 120, input unit 130, display unit 140, storage unit 150, location calculator 160, world time calculator 170, schedule information extractor 180, alarm generator 190, and control unit 200.

The communication unit 110 performs wireless communication of the mobile terminal. The communication unit 110 converts a radio frequency signal received through a communication network to a signal in an intermediate frequency, transmits the signal to the control unit 200, and transmits a signal received from the control unit 200 through the communication network. In particular, the communication unit 110 receives the current time from a base station of the area in which the mobile terminal is located, and connects to an external server such that a user may search for a city name through a wireless Internet connection.

The GPS receiver 120 receives a signal from a GPS satellite and transmits the signal to the location calculator 160.

The input unit 130 may be formed with a touch screen or a keypad having alphanumeric keys, special character keys, various function keys and the like, and transmits an input signal for registering or searching schedule information to the control unit 200.

The display unit 140 may be formed with a liquid crystal display (LCD), and displays various data generated in the mobile terminal. The display unit 140 may display a screen for registering or searching schedule information and a screen of schedule information on a city.

The storage unit 150 may store programs and data required for general operation of the mobile terminal, such as schedule information, locations and time differences by cities, world map data indicating major cities in the world and the like.

The storage unit 150 may store schedule information in a database form as shown in Table 1.

TABLE 1

| | Corres- | | | |
|---|---|---|---|---|
| City | pondence | Execution | | |
| name | city name | time | Schedule item | Memo |
| London | London | 04-09-2006 | Reservation of | Departure |
| | | 12:00 | train for Paris | intervals: |
| | | | | 1 hr |
| Paris | Paris | 04-25-2006 | Lunch with | Check |
| | | 12:00 | customer at | brochures for |
| | | | Restaurant | exhibition at |
| | | | Stella Maris | Arc de |
| | | | | Triomphe |
| | | | | branch |
| Seattle | Seattle | 05-04-2006 | Attend ISMRM | |
| | | 14:00 | conference | |
| | Paris | 05-04-2006 | Telephone call | Regarding |
| | | 09:00 | to Paris branch | conference |
| New York | New York | 05-07-2006 | Attend Musical | Theater |
| | | 19:00 | ‘Ghost of | Broadway |
| | | | Opera’ | Majestic |
| | | | | 35% |
| | | | | discounted |
| | | | | ticket |
| | | | | available at |
| | | | | ticket box of |
| | | | | Time Square |
| . . . | . . . | . . . | . . . | . . . |

For example, in the fifth row of Table 1, ‘Telephone call to Paris branch’ corresponds to an item of a schedule to be executed by a user. ‘Seattle’ corresponds to the name of the city in which the schedule item is to be executed. ‘Paris’ corresponds to a name of a correspondence city. ‘05-04-2006 09:00’ corresponds to an execution time in the local time of the correspondence city at which the scheduled item is to be executed.

The storage unit 150 may store locations and time differences by cities in a database form as shown in Table 2.

TABLE 2

| City name | Location | Time difference (hr) |
|---|---|---|
| London | xxxxxh | −9 |
| Paris | xxxxxh | −8 |
| Seattle | xxxxxh | −17 |
| New York | xxxxxh | −14 |
| . . . | . . . | . . . |

In an exemplary embodiment, time differences are described by assuming that the local time of Seoul is 00:00. The world time calculator 170 calculates the local time of a city by using the locations and time differences shown in Table 2.

For example, in the case that the local time of London is 10:00 am, the local time of Paris becomes 11:00 am, because the time difference between London and Paris is 1 hour.

The storage unit 150 may store world map data for a user's convenience when inputting a city name for registering schedule information.

The locations and time differences by cities and the world map data may be pre-stored in a manufacturing process of the mobile terminal, may be obtained and updated by downloading the world map data from an information providing server and may be obtained and updated by other applicable methods.

The location calculator 160 determines, by using a signal received from the GPS receiver 120, information on the location in which the mobile terminal is currently located.

The world time calculator 170 retrieves a time difference stored in the storage unit 150 corresponding to the determined location information, and determines the local time of the city in which the mobile terminal is currently located.

The world time calculator 170 then determines the local time of a correspondence city shown in Table 1, and determines the time difference between the local time of the city in which the mobile terminal is located and the local time of the correspondence city by using the locations and time differences shown in Table 2.

The schedule information extractor 180 extracts schedule information from the storage unit 150 corresponding to a city name input by a user through the input unit 130.

The execution time of a schedule item included in the schedule information is converted to the local time of the city in which the mobile terminal is currently located by the world time calculator 170. If the converted execution time is identical to the local time of the city in which the mobile terminal is currently located, the schedule information extractor 180 extracts the schedule information corresponding to the execution time.

If the converted execution time is identical to the local time of the city in which the mobile terminal is currently located, the alarm generator 190 may generate an alarm notifying of a schedule item corresponding to the converted execution time.

In an exemplary embodiment, the alarm is generated by using one of a sound, vibration, light and the like, and the schedule item is displayed on the display unit 140.

The control unit 200 controls general operation of the mobile terminal, and controls the alarm generator 190 to generate an alarm if the converted execution time is identical to the local time of the city in which the mobile terminal is located.

Additionally, the control unit 200 controls operation of the display unit 140 by mapping schedule information stored in the storage unit 150 to world map data.

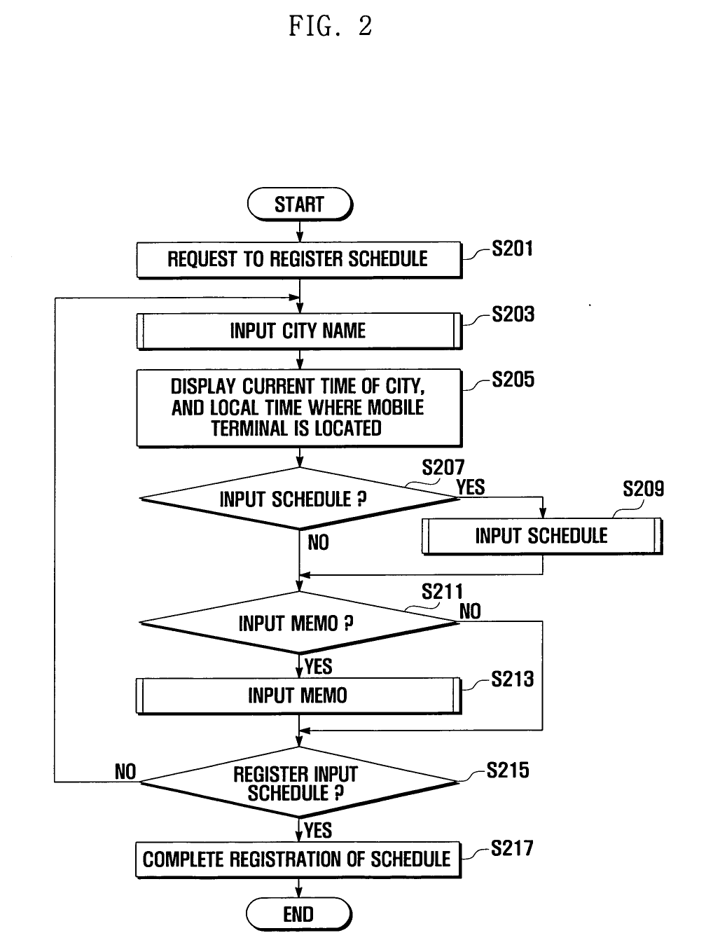

FIG. 2 is a flow chart showing a method for registering schedule information in a mobile terminal according to an exemplary embodiment of the present invention.

Referring to FIG. 2, a request signal for registering schedule information is input by a user (S201).

The schedule information may be registered by mapping a schedule to a name of a city in which the schedule is to be executed by the user. For this, the schedule information may include a city name, schedule, memo and the like.

The schedule may include execution time, name of correspondence city, schedule item and the like.

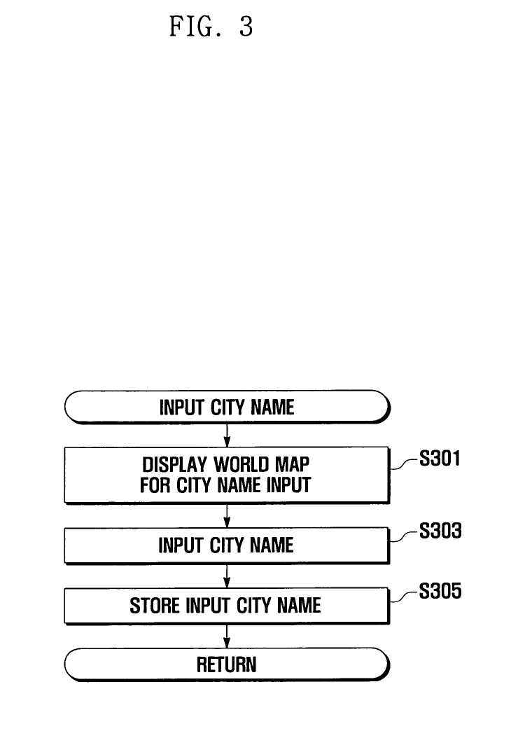

When a request signal for registering schedule information is input by the user in the step S201, the mobile terminal receives a city name input by the user (S203). The step S203 of inputting a city name is described in detail later referring to FIG. 3. For user convenience in registering schedule information, the mobile terminal may display the current local time of the city whose name is input by the user and the local time of a city in which the mobile terminal is located (S205).

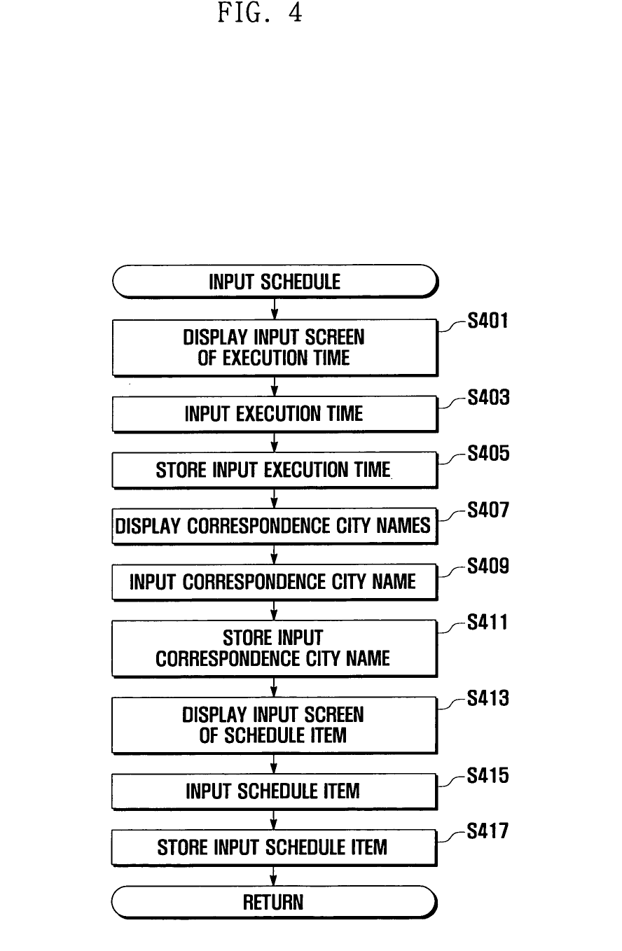

The mobile terminal identifies whether a request signal for inputting a schedule is input by the user (S207). If a request signal is input, the mobile terminal receives a schedule input by the user (S209). The step S209 of inputting a schedule is described in detail later referring to FIG. 4.

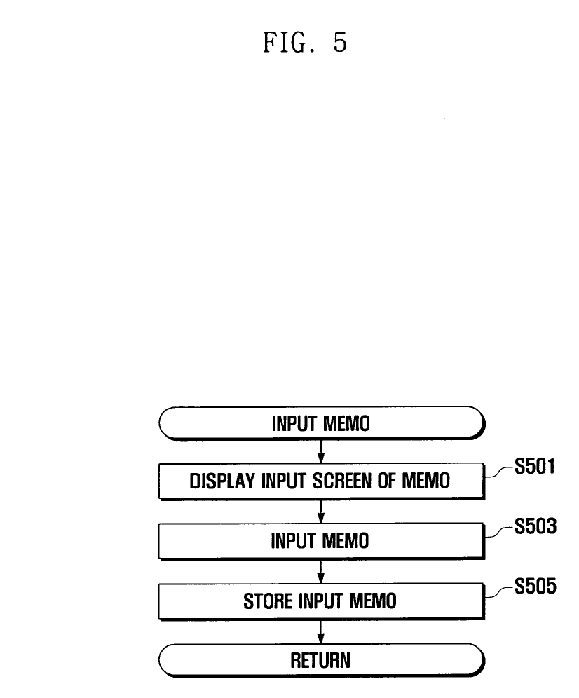

The mobile terminal identifies whether a request signal for a memo is input by the user (S211). If a request signal for a memo is input by the user, the mobile terminal receives the memo (S213). The step S213 of inputting a memo is described in detail later referring to FIG. 5.

The mobile terminal then identifies whether a request signal for registration of schedule information such as a city name, schedule, memo and the like is input (S215). If a request signal for registration of schedule information is input, the mobile terminal completes the registration of schedule information by mapping the schedule input in the step S209 and the memo input in the step S213 to the city name input in the step S203 (S217).

Although the steps of registering schedule information have been described in the order of city name, schedule, and memo in an exemplary embodiment, the present invention may include other methods for registering the schedule information, including registering the schedule information in different orders.

FIG. 3 is a flow chart showing steps of inputting a city name in an exemplary method for registering schedule information of FIG. 2.

The mobile terminal displays a city name input screen on the display unit 140 such that the user may input a city name (S301). The city name input screen may be displayed as a world map in which a city currently registered with schedule information and a city not registered with schedule information are distinguished. For this, the mobile terminal may store world map data in the storage unit 150. The city name input screen may be displayed in a form listing cities that are registered with schedule information, in addition to the world map mapped with the schedule information.

A city name is input by the user for selection of a city to be registered with schedule information (S303).

When a city name is input, the mobile terminal stores the input city name (S305). In an exemplary embodiment of the present invention, the method of inputting a city name utilizes a touch screen or a keypad.

FIG. 4 is a flow chart showing steps of inputting a schedule item in an exemplary method for registering schedule information of FIG. 2.

The mobile terminal displays an input screen for execution time on the display unit 140 such that the user may input an execution time (S401). The execution time indicates time information for a schedule item to be executed in the city of the name input by the user in the step S203.

When an execution time is input by the user (S403), the mobile terminal stores the input execution time (S405).

The mobile terminal then displays an input screen for a correspondence city name on the display unit 140 (S407), so that the user may input a correspondence city name (S409).

The correspondence city name indicates the name of a city in which another party is located. For example, in the schedule ‘Seattle, 05-04-2006 09:00, Telephone call to Paris branch’, the execution time is ‘05-04-2006 09:00’ and the correspondence city name is ‘Paris’. When a correspondence city name is input by the user, the mobile terminal stores the input correspondence city name (S411).

Subsequently, the mobile terminal displays an input screen for a schedule item on the display unit 140 (S413), so that the user may input a schedule item (S415). The schedule item indicates a schedule to be executed by the user in the city of the name input in the step S203.

When a schedule item is input by the user, the mobile terminal stores the input schedule item (S417).

FIG. 5 is a flow chart showing steps of inputting a memo in an exemplary method for registering schedule information of FIG. 2.

The mobile terminal displays an input screen for a memo on the display unit 140 such that the user may input a memo (S501).

When a memo is input by the user for a city to be registered with schedule information (S503), the mobile terminal stores the input memo (S505).

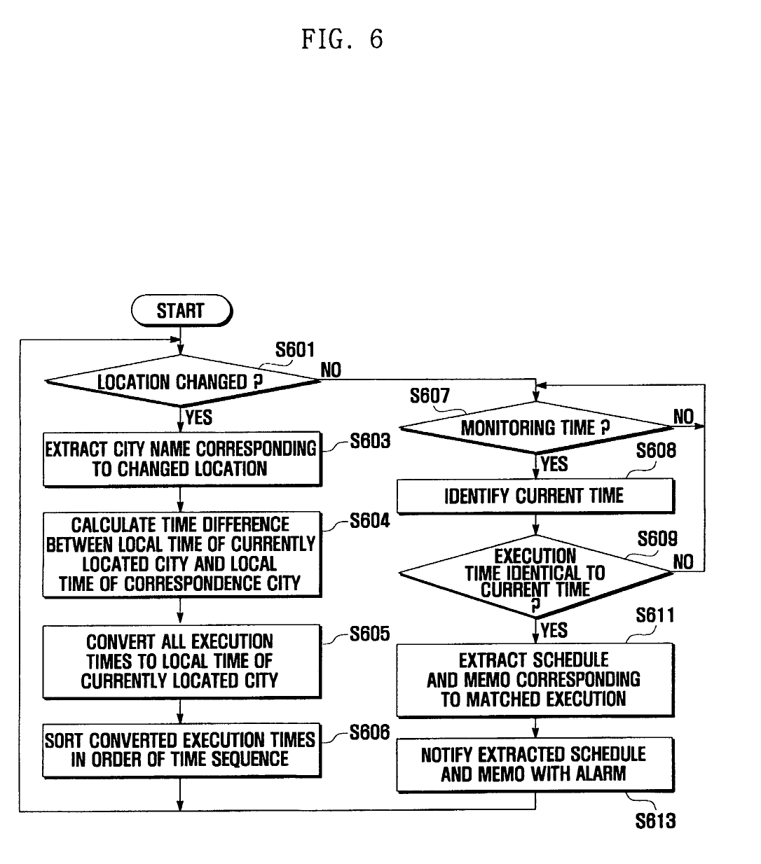

FIG. 6 is a flow chart showing a method for notifying of a schedule item in a mobile terminal according to an exemplary embodiment of the present invention.

Referring to FIG. 6, the mobile terminal determines the location of the mobile terminal, and determines a location change of the mobile terminal (S601). A location change may include a change in location from a user's designated home location, from a location in which schedule information was input, from the city name information input as part of the schedule input, and the like.

The location change may be determined by using signals received from GPS satellites, by using location information received from a base station or other applicable methods.

If a location change of the mobile terminal is identified, the mobile terminal extracts a city name corresponding to the location information on the mobile terminal calculated in the step S601 (S603). The city name may be extracted from the locations and time differences by cities stored in the storage unit 150 shown in Table 2.

The mobile terminal calculates the time difference between the local time of a city in which the mobile terminal is located and the local time of a correspondence city (S604). The time difference may be extracted from the locations and time differences by cities stored in the storage unit 150 shown in Table 2.

The mobile terminal converts all execution times that are included in schedule information currently registered in the mobile terminal to the local time of the city in which the mobile terminal is located by using the time difference calculated in the step S604 (S605).

The mobile terminal sorts the converted execution times in the order of time sequence (S606).

The mobile terminal returns to the step 601, and determines again whether the location of the mobile terminal is changed (S601). If the location of the mobile terminal has not changed, the mobile terminal identifies whether a time point for monitoring current time has been reached (S607). The current time of the city in which the mobile terminal is located is periodically monitored. For example, if the user has set the period interval of monitoring current time to 1 second, the mobile terminal checks, every 1 second, the current time of the city in which the mobile terminal is located.

If the time point for monitoring the current time has not been reached, the mobile terminal waits until the monitoring time point is reached.

If the time point for monitoring the current time has been reached in the step S607, the mobile terminal determines the current time of the city in which the mobile terminal is located (S608), and determines whether an execution time converted in the step S605 is identical to the current time obtained in the step S608 (S609).

If a converted execution time is identical to the current time, a schedule item and memo are extracted from the schedule information corresponding to the matched execution time (S611), and the extracted schedule item and memo are displayed on the display unit 140 with a notice (S613). The notice may be performed by using at least one of a sound, vibration, light and the like.

If a converted execution time is not identical to the current time in the step S609, the procedure returns to the step S607.

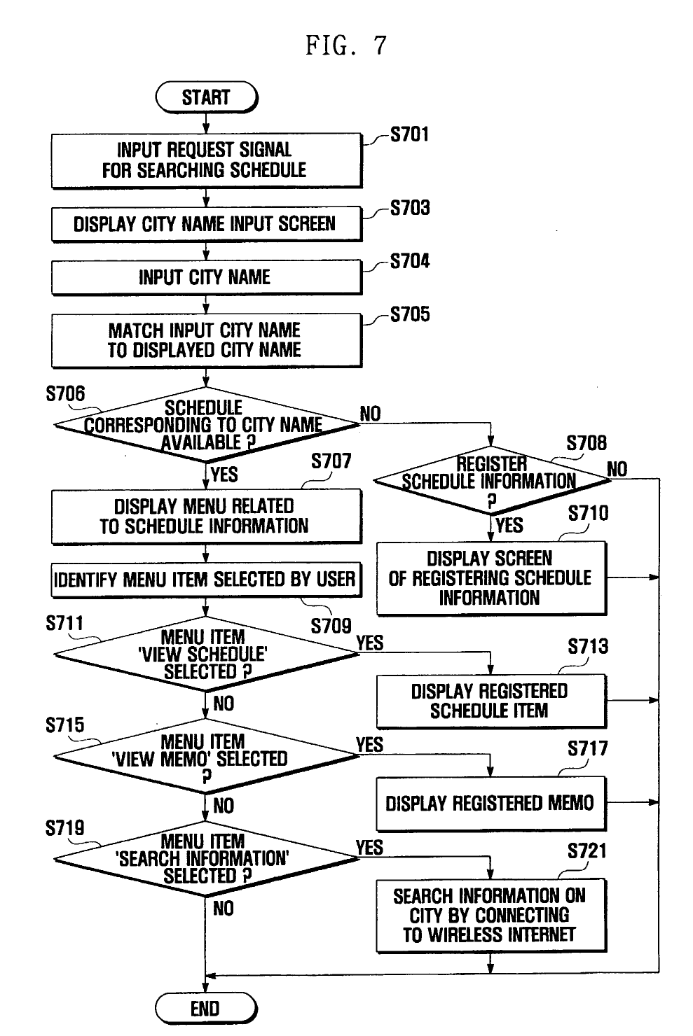

FIG. 7 is a flow chart showing a method for searching a schedule in a mobile terminal according to an exemplary embodiment of the present invention.

Referring to FIG. 7, a request signal for searching schedule information is input by the user (S701). The mobile terminal displays a city name input screen on the display unit 140 (S703) such that the user may input a city name for searching schedule information (S704).

The city name input screen may be displayed as a world map in which a city currently registered with schedule information and a city not registered with schedule information are distinguished. For this, the mobile terminal may store world map data in the storage unit 150. The city name input screen may be displayed in a form listing cities that are registered with schedule information, in addition to the world map mapped with the schedule information.

The mobile terminal matches a city name input by the user to one of the city names displayed on the input screen for searching schedule information (S705).

The mobile terminal then identifies whether schedule information corresponding to the input city name is available (S706).

If schedule information is available, the schedule information and a menu corresponding to the city name are displayed (S707).

The schedule information may include a memo in addition to a schedule item, and may display a selection menu such as ‘View schedule’, ‘View memo’, ‘Search information’ and the like for user convenience in searching the schedule item and memo. The selection menu enables the user to search schedule information for the selected city.

The mobile terminal then identifies an item selected by the user from the displayed selection menu (S709). If ‘View schedule’ is selected by the user (S711), a schedule item, execution time, correspondence city name and the like corresponding to the input city name may be displayed on the display unit 140 (S713).

If ‘View memo’ is selected by the user (S715), a memo corresponding to the input city name may be displayed on the display unit 140 (S717).

If ‘Search information’ is selected by the user (S719), the mobile terminal searches information related to the selected city by connecting to an external server through a wireless Internet (S721).

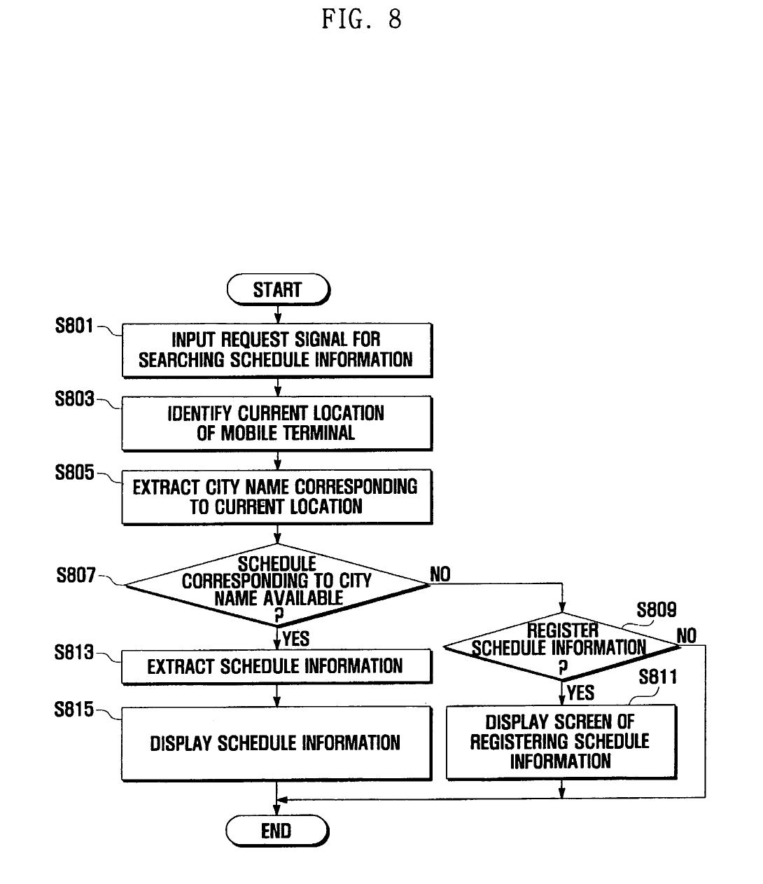

FIG. 8 is a flow chart showing a method for searching a schedule in a mobile terminal according to an exemplary embodiment of the present invention.

A request signal for searching schedule information corresponding to the current location of the mobile terminal is input by the user (S801).

When the request signal is input, the mobile terminal identifies the current location of the mobile terminal (S803).

The location of the mobile terminal may be identified by using signals received by a GPS receiver of the mobile terminal from GPS satellites.

In the case of a mobile terminal without a GPS receiver, the mobile terminal may identify its location by receiving a signal from a base station or other available method.

The mobile terminal then extracts a city name corresponding to the current location from a database of locations and time differences by cities (S805), and identifies whether schedule information corresponding to the extracted city name is available (S807).

If schedule information corresponding to the extracted city name is available in the step S807, the mobile terminal extracts the schedule information (S813), and displays the extracted schedule information on the display unit 140 (S815).

If schedule information corresponding to the extracted city name is not available in the step S807, the mobile terminal identifies whether a request signal for registering schedule information corresponding to the extracted city name is input (S809). If the request signal has been input, the mobile terminal displays a screen of registering schedule information (S811).

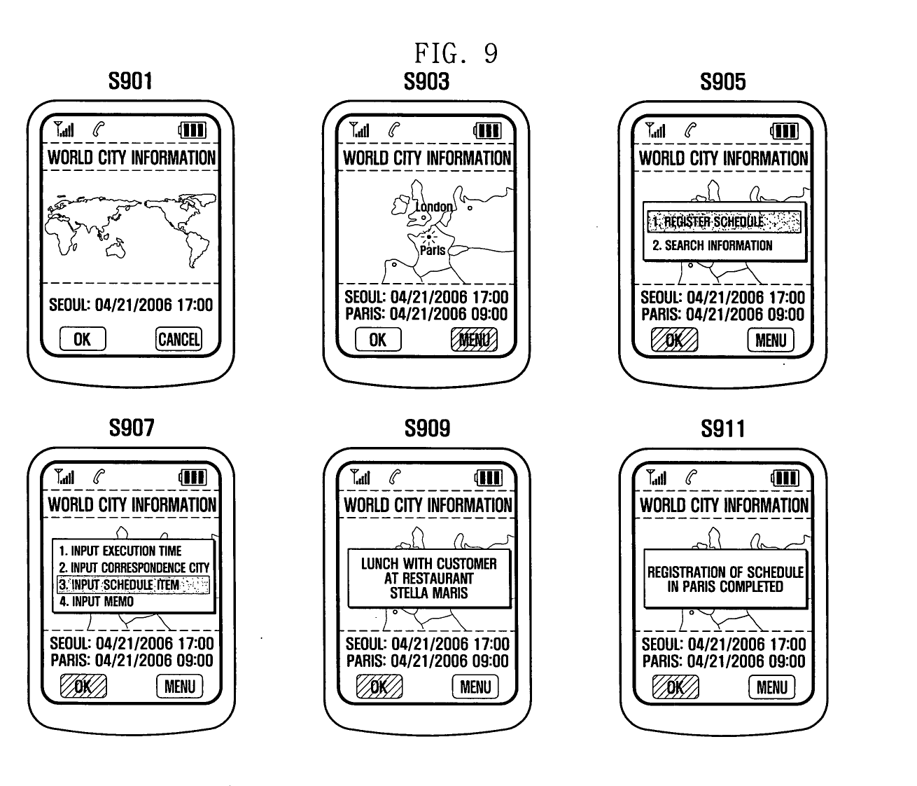

FIG. 9 is a view showing examples of screen displays for registering schedule information according to an exemplary embodiment of the present invention.

Referring to FIG. 9, if a request signal for registering schedule information is input by the user, the mobile terminal displays a city name input screen on the display unit 140 such that the user may input a city name for registering schedule information (S901).

The city name input screen may be displayed as a world map in which a city currently registered with schedule information and a city not registered with schedule information are distinguished. For this, the mobile terminal may store world map data in the storage unit 150.

Subsequently, the user selects a city (for example, ‘Paris’) for registering schedule information among cities displayed on a world map by using a touch screen or direction keys of a keypad, and presses a ‘Menu’ button (S903).

The mobile terminal may display the current time of a city (for example, ‘Seoul’) in which the mobile terminal is located and the local time of a city (for example, ‘Paris’) to which schedule information is to be registered.

If the user selects ‘Paris’ in the city name input screen and presses the ‘Menu’ button, the mobile terminal displays a menu related to schedule information on the display unit 140.

The menu related to schedule information may include ‘Register schedule’, ‘Search information’, and others (S905).

If the user selects a menu item for registering schedule information from the displayed menu and presses an ‘OK’ button, the mobile terminal displays a menu for registering execution time, correspondence city name, schedule item, memo and the like (S907).

Subsequently, the user inputs desired information of a schedule item (for example, Lunch with customer at Restaurant Stella Maris), execution time (for example, 04-25-2006 12:00), and correspondence city name (for example, Paris) (S909).

The display screen S909 shows an example screen of inputting a memo. Registration of schedule information for Paris is completed by pressing the ‘OK’ button (S911).

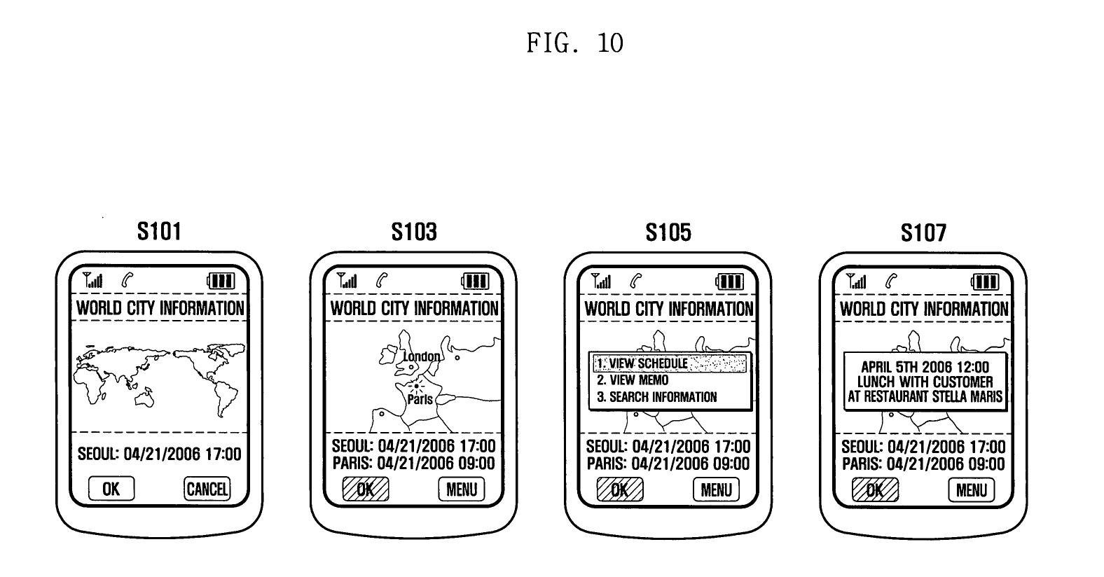

FIG. 10 is a view showing examples of screen displays for searching schedule information registered according to an exemplary embodiment of the present invention.

Referring to FIG. 10, if a request signal for searching schedule information is input by the user, the mobile terminal displays a screen of selecting a city on the display unit 140 such that the user may select a city for searching schedule information (S101).

As shown in the display screen S101, the screen for selecting a city may be displayed as a world map in which a city currently registered with schedule information and a city not registered with schedule information are distinguished.

Subsequently, the user selects a city (for example, ‘Paris’) for searching schedule information among cities displayed on the world map by using a touch screen, direction keys of a keypad and the like, and presses a ‘Menu’ button. At this moment, the mobile terminal may display, at the bottom of the screen, the current time of a city (for example, ‘Seoul’) in which the mobile terminal is located, and the local time of the city (for example, ‘Paris’) selected by the user.

If the user selects “Paris’ as a city name and presses the ‘OK’ button (S103), the mobile terminal displays a sub-menu related to the schedule information such as ‘View schedule’, ‘View memo’, and ‘Search information’ (S105).

The ‘Search information’ is a sub-menu used in the case that information on the selected city is to be searched by connecting to an external server through a wireless Internet, and the selected city name ‘Paris’ is set as an initial value in a search window. In an exemplary embodiment, the ‘Search information’ function may be used to search other information desired by the user in addition to the previously-described city name.

If the user selects ‘View schedule’ from the displayed menu and presses the ‘OK’ button, the mobile terminal displays pre-stored schedule information ‘04-25-2006 12:00, Lunch with customer at Restaurant Stella Maris’ on the screen of the display unit 140 (S107).

If a memo is registered in the schedule information, the mobile terminal displays the memo (for example, ‘Check brochures for exhibition at Arc de Triomphe branch’) on the screen of the display unit 140.

Certain exemplary embodiments of the present invention can also be embodied as computer-readable codes on a computer-readable recording medium. The computer-readable recording medium is any data storage device that can store data which can thereafter be read by a computer system. Examples of the computer-readable recording medium include, but are not limited to, read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments for accomplishing the present invention can be easily construed as within the scope of the invention by programmers skilled in the art to which the present invention pertains.

As described above, the present invention provides a notifying function of an item of schedule to be executed by a user at an execution time registered with schedule information by world cities, and thereby a schedule to be executed in a corresponding city may be managed in a convenient method. Additionally, the present invention provides an improved efficiency of the schedule management, because schedule items and memos may be managed in the unit of city.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims.

What is claimed is:

1. A schedule management method in a mobile terminal, the method comprising:
converting, if the location of a mobile terminal changes, an execution time of a schedule to a local time of a city in which the mobile terminal is located, and notifying a user of the mobile terminal of the schedule at the converted execution time; and
notifying, if the location of the mobile terminal does not change, the user of the mobile terminal of the schedule at the execution time in a local time of a city in which the mobile terminal is located.

2. The schedule management method of claim 1, wherein the schedule comprises a schedule to be executed by the user at a time set for a corresponding city, and a name of a city in which the schedule is to be executed.

3. The schedule management method of claim 2, wherein the schedule further comprises an item to be executed by the user, the execution time of the item, and a name of a correspondence city.

4. The schedule management method of claim 1, wherein the schedule comprises a memo.

5. The schedule management method of claim 1, wherein the converting of the execution time of the schedule comprises:
obtaining location information of the mobile terminal and extracting a city name and time differences by cities corresponding to the obtained location information from a database of locations;
determining a time difference between the local time of the extracted city name and the local time of a correspondence city name;
converting the execution time to the local time of the correspondence city by using the determined time difference; and
sorting the converted execution times in order of time sequence.

6. The schedule management method of claim 1, wherein the notifying of the schedule comprises:
monitoring the current time of the city in which the mobile terminal is located;
comparing the converted execution time with the monitored current time;
extracting, if the converted execution time and the monitored current time are identical, a schedule item corresponding to the converted execution time; and
outputting a notice of the extracted schedule item with an alarm.

7. The schedule management method of claim 6, wherein the outputting of the notice of the extracted schedule item with an alarm comprises annunciating the extracted schedule item via a display unit by using at least one of a sound, vibration, and light.

8. The schedule management method of claim 1, further comprising:
displaying an input screen on the mobile terminal such that the user may input a city name for searching the schedule by cities;
identifying whether the city name is input by the user; and
displaying, if the city name is input, schedule information corresponding to the input city name.

9. The schedule management method of claim 8, wherein the displaying of the input screen for the city name comprises displaying by differentiating city names for which schedule information is currently registered in the mobile terminal from city names for which schedule information is not registered in the mobile terminal.

10. The schedule management method of claim 8, wherein the displaying of the schedule information corresponding to the input city name comprises searching a city name by connecting to an external server through a wireless Internet such that the user may search information related to the input city name.

11. The schedule management method of claim 1, further comprising:
identifying whether a request signal for searching schedule information corresponding to the current location of the mobile terminal is input by the user;
calculating, if the request signal is input, location information corresponding to the current location of the mobile terminal;
extracting a city name corresponding to the calculated location information; and
displaying schedule information corresponding to the extracted city name.

12. The schedule management method of claim 11, wherein the displaying of the schedule information corresponding to the extracted city name comprises comparing the local time of the extracted city name with the local time of a correspondence city name, and converting, if the local time of the extracted city name is not identical to the local time of the correspondence city name, execution time of a schedule for the correspondence city name to the local time of the extracted city name.

13. The schedule management method of claim 1, further comprising:
inputting a city name for registering schedule information;
inputting a schedule to be executed in the city of the input city name;
registering the input schedule information by mapping the input schedule information to the input city name.

14. The schedule management method of claim 13, wherein the registering of the input schedule further comprises adding a memo to the input city name.

15. The schedule management method of claim 13, wherein the inputting of the schedule comprises:
inputting an execution time of the schedule to be executed in the city of the input city name;
inputting a name of a correspondence city in which another party of the schedule is located; and
inputting a schedule item.

16. A mobile terminal for storing schedule information, comprising:
an input unit for inputting a signal for storing or searching the schedule information, and transmitting the signal to a control unit;
a display unit for displaying an input screen for registering or searching the schedule information, and for notifying the schedule information;
a storage unit for storing the schedule information, location of city and time difference by cities, and world map data;
a location calculator for calculating a location in which the mobile terminal is currently located by using a signal received from a GPS receiver;
a world time calculator for calculating the time difference between the local time of a city in which the mobile terminal is located and the local time of a correspondence city by using the locations and time differences stored in the storage unit;
a schedule information extractor for extracting the location of a city calculated by the location calculator and schedule information corresponding to a city name input by a user; and
an alarm generator having at least one of a speaker, vibrator, and lamp, for generating an alarm to notify of the extracted schedule information.

17. A method of schedule management in a mobile terminal, the method comprising:
determining if a location of a mobile terminal has changed;
converting an execution time of an item scheduled in the mobile terminal to a local time of the location of the mobile terminal if the location of the mobile terminal has changed; and
notifying a user of the mobile terminal of the scheduled item at the execution time.

18. The schedule management method of claim 17, wherein the determining if the location of the mobile terminal has changed comprises:
determining the location of the mobile terminal;
comparing the location of the mobile terminal to at least one of a designated home location of the user, a location in which schedule information was input, and city name information comprising part of the schedule item.

19. The schedule management method of claim 18, wherein the converting of the execution time of the scheduled item comprises:
determining a city name and time difference corresponding to the determined location of the mobile terminal from a database of locations;
determining a time difference between the local time of the determined city name and the local time of a correspondence city name;
converting the execution time to the local time of the correspondence city by using the determined time difference; and
sorting the converted execution times in order of time sequence.

20. The schedule management method of claim 18, wherein the determining of the location of the mobile terminal comprises receiving a global positioning service (GPS) signal by a GPS receiver.

21. A computer readable medium having stored thereon instructions for executing a method of schedule management in a mobile terminal, the instructions comprising:
a first set of instructions for determining if a location of a mobile terminal has changed;
a second set of instructions for converting an execution time of an item scheduled in the mobile terminal to a local time of the location of the mobile terminal if the location of the mobile terminal has changed; and
a third set of instructions for notifying a user of the mobile terminal of the scheduled item at the execution time.
